(19) United States
(12) Patent Application Publication
(10) Pub. No.: US 2002/0037717 A1
(43) Pub. Date: Mar. 28, 2002

(54) Method for operating a preferably mobile telecommunication system

(75) Inventors: Manfred Laube, Keltern 1 (DE); Manfred Weiss, Neuhausen (DE)

Correspondence Address: SUGHRUE, MION, ZINN, MACPEAK & SEAS, PLLC, 2100 Pennslyvania Avenue, N.W., Washington, DC, 20037-3213, US

(73) Assignee: ALCATEL

(21) Appl. No.: 09/955,057

(22) Filed: Sep. 19, 2001

(30) Foreign Application Priority Data
Sep. 22, 2000 (DE) 100 47 002.5

(51) Int. Cl. H04Q 7/20

(52) U.S. Cl. 455/422; 455/435; 455/448

(57) ABSTRACT

A telecommunication system is described, which has a public network to which at least one terminal is coupled via an connecting device. The location of the connecting device is stored in the connecting device. The location of the connecting device is entered manually or determined automatically

The invention is based on a priority application DE 100 47 002.5 which is hereby incorporated by reference.

### BACKGROUND OF THE INVENTION

The invention relates to a method for operating a preferably mobile telecommunication system, in which at least one terminal is coupled via an connecting device to a public network. The invention also relates to a telecommunication system having a public network to which at least one terminal is coupled via an connecting device.

The terminal may, for example, be a preferably portable personal computer within a LAN (local area network), preferably within a WLAN (wireless local area network). The LAN, and hence the personal computer, are in this case connected to the public network with the aid of the connecting device.

The terminal may also be a preferably portable personal computer which is not linked into a LAN. In this case, the connecting device may be e.g. a modem, using which the personal computer can be connected to the public network.

In the first case, the entire LAN or WLAN may be taken to another location. If, for example, the LAN or WLAN is allocated to a building site, then the LAN or WLAN can be set up again on another building site, and hence at another location, after work on the building site has been completed.

In the second case, the personal computer may be moved by its user between various locations, where it is used.

This entails the problem that the LAN or WLAN, or the personal computer, may sometimes need to operate differently at the different locations. It is necessary to take this into account in some way.

### SUMMARY OF THE INVENTION

The aforementioned problem, in the case of a method of the type mentioned in the introduction, is solved according to the invention by the fact that the location of the connecting device is entered manually or determined automatically. In the case of a telecommunication system of the type mentioned in the introduction, the aforementioned problem is solved by the fact that the location of the connecting device is stored in the connecting device.

The current location of the connecting device, and hence the location of the LAN or WLAN, or of the personal computer, is therefore known and can be utilised. This affords the advantage that this location can be taken into account when the terminal in question is being operated.

In the first case mentioned in the introduction, this achieves the effect, within a LAN or WLAN which belongs to a particular building site, of providing only the data concerning that building site. Hence, not only is the required data traffic reduced, but this also ensures, for example, that the appropriate building plans are always available at the building site in question.

In the second case mentioned in the introduction, this achieves the advantage that, at any location to which he or she goes, the user only ever receives the data relevant to this location, for example regarding petrol stations, hotels etc. This again reduces the data traffic and, furthermore, increases the user friendliness.

In a preferred embodiment of the method according to the invention, the location of the connecting device is determined with the aid of satellites, in particular with the aid of GPS satellites. As an alternative, or in addition, it is possible for the location of the connecting device to be determined with the aid of information which is broadcast by wireless public networks, in particular by GSM and UMTS networks.

These constitute particularly simple and expedient ways in which the location of the connecting device can be determined automatically. In particular, GPS-dependent determination of this location is particularly accurate and reliable.

It is furthermore useful if a fixed LAN is connected to the public network and if only data associated with the location of the connecting device is transmitted from the LAN to the terminal. This substantially reduces the data traffic between the terminal and the fixed LAN, with all the resulting advantages.

In advantageous development of the telecommunication system according to the invention, the connecting device is provided with means for automatically determining the location of the connecting device. These may be GPS- and/or GSM-dependent means.

In a first alternative, the terminal and the connecting device are components of a preferably wireless LAN. This LAN or WLAN may then, for example, be used successively at various building sites with different locations. In a second alternative, the terminal and the connecting device are designed as an integrated device, for example as a personal computer or as a telephone. This integrated device may then be moved by its user between various locations, where it is used.

Other features, possible applications and advantages of the invention can be found in the following description of exemplary embodiments of the invention, which are represented in the figures of the drawing. All described or represented features, per se or in any combination, form the subject matter of the invention, irrespective of their summary in the patent claims or the interdependency of the latter, and irrespective of their formulation or representation in the description, or in the drawing.

### BRIEF DESCRIPTION OF THE DRAWINGS

FIG. 1 shows a schematic block diagram of a first exemplary embodiment of a telecommunication system according to the invention, and

FIG. 2 shows a schematic block diagram of a second exemplary embodiment of a telecommunication system according to the invention.

### DESCRIPTION OF PREFERRED EMBODIMENTS

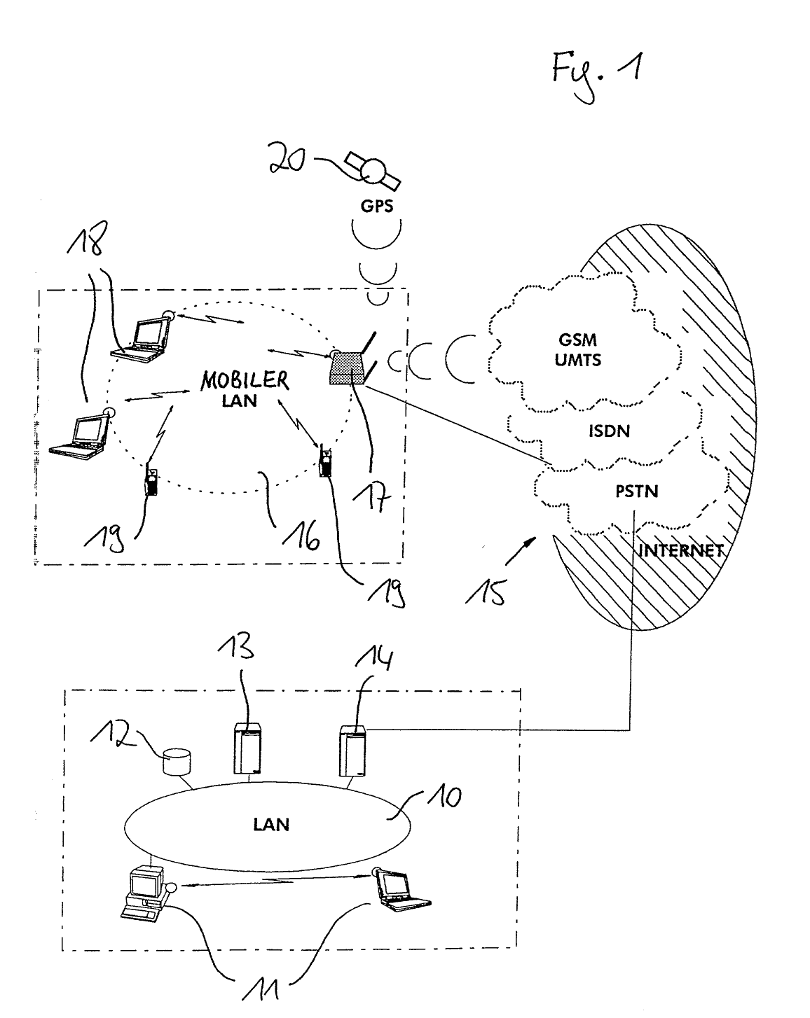

FIG. 1 represents a fixed LAN (local area network) 10 which, for example, is used in a company to permit, inter alia, communication between the employees and access by the employees to databases. To that end, fixed and portable personal computers 11 for the employees and databases 12 are connected to the LAN 10. The LAN 10 is operated with the aid of a LAN server 13.

Via a so-called router 14, the fixed LAN 10 is connected, preferably in wired fashion, to one or more public networks 15. These may be a PSTN (public switched telephone network), an ISDN (integrated services digital network), a GSM (global system for mobile communication), a UMTS (universal mobile telecommunication system), the Internet or the like.

FIG. 1 also represents a mobile LAN 16, which is arranged outside the local area of the fixed LAN 10, and therefore geographically remote from the fixed LAN 10. The LAN 16 is used, inter alia, so that company employees who are working outside the local area of the fixed LAN 10 can communicate with the other company employees and can access the databases 12.

To that end, the mobile LAN 16 is provided with an connecting device 17, which is connected wirelessly and/or in wired fashion to the one or more public networks 15. The LAN 16 furthermore has a plurality of terminals, preferably portable personal computers 18 and mobile telephones 19.

If the company is a building company, for example, then the mobile LAN 16 may be allocated to a building site which is contracted to the company. Company employees who are working on this building site can then telephone one another and exchange data with one another via the mobile LAN 16. These employees can furthermore access the fixed LAN 10 from the mobile LAN 16 via the public networks 15. The employees on the work site, and hence in the area of the mobile LAN 16, can therefore communicate with the employees inside the area of the fixed LAN 10. Employees on the work site can also access the databases 12 of the fixed LAN 10.

The connecting device 17 is suitable for storing its own location, and hence the location of the mobile LAN 16. This location can be made available in a variety of ways.

It is possible for the location to be entered manually into the connecting device 17 in the form of coordinates, or in a different way. This entering may take place, for example, when the building site is first started.

It is also possible for the location of the connecting device 17, and hence the location of the mobile LAN 16, to be determined automatically. This may be done by the connecting device 17 itself. To that end, the connecting device 17 may be provided with means, and may be suitable, for processing the information broadcast by satellites 20 of a positioning system, e.g. by GPS satellites (GPS=global positioning system), and for deriving its location automatically therefrom. The connecting device 17 may also be capable of deducing its location, and hence the location of the mobile LAN 16, from the information broadcast by the wireless public networks, i.e. in particular by the GSM and UMTS networks, e.g. the cell ID and/or position measurements relating to various base stations (NMR=network measure radio).

With the aid of the stored location of the connecting device 17, and hence of the mobile LAN 16, the connecting device 17 is suitable for generating and forwarding location-dependent information. This location-dependent information may be passed, on the one hand, to the employees connected inside the mobile LAN 16, i.e. to their personal computers 18 or telephones 19, and, on the other hand, via the public networks 15, to the employees connected inside the fixed LAN 10, i.e. to their personal computers 11, as well as to the databases 12 and the LAN server 13.

The location-dependent information can therefore be used by the databases 12 so that only the data relevant to the mobile LAN 16 is ever downloaded from the database 12 to this mobile LAN 16. For instance, only the building plans relevant to the building site associated with the LAN 16 are downloaded from the database 12 and transmitted to the LAN 16. The employees on the building site hence no longer need to take care and ensure that they do actually receive the data associated with their building site; instead, this is automatically achieved with the aid of the location-dependent information.

The location-dependent information may furthermore be used so that all the employees, who are connected to the mobile LAN 16, are always automatically provided with all the news and the like relating to the local area of the mobile LAN 16. For instance, the times and locations of meetings which relate to the building site associated with the mobile LAN 16 may be automatically distributed within this mobile LAN 16, but not within the fixed LAN 10. This also achieves the effect that the news relevant to the building site of the mobile LAN 16 is only distributed inside this building site, but not outside.

Once work on the building site has been completed and stopped, the connecting device 17 may be taken to another location and installed. The new location may then in turn be entered manually or determined automatically there. The devices already mentioned in connection with the mobile LAN 16 may then be connected to the connecting device 17, and a new mobile LAN can in this way be set up. This achieves the effect that the connecting device 17 always has stored the location where the mobile LAN in question is situated.

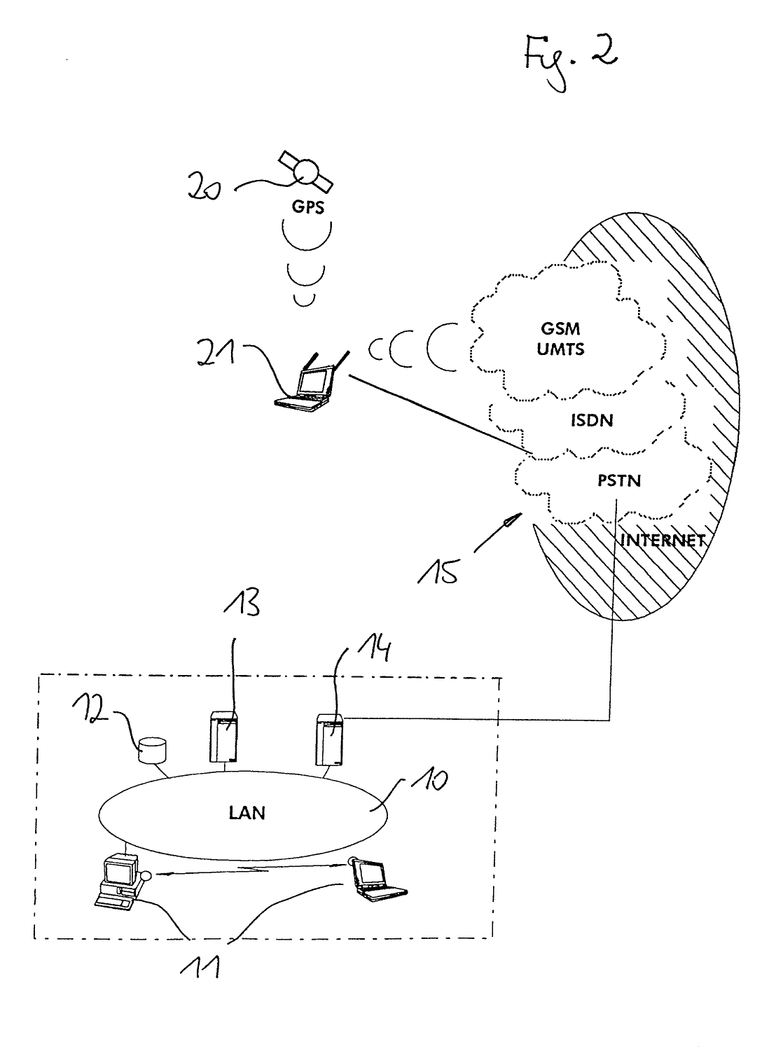

FIG. 2 represents a telecommunication system which substantially corresponds to the telecommunication system in FIG. 1. For this reason, the parts which correspond to one another are identified by the same reference numbers.

Instead of the mobile LAN 16 of FIG. 1, however, a portable personal computer 21 is provided as the terminal in FIG. 2. An connecting device, which corresponds to the connecting device 17 in FIG. 1, is integrated in this personal computer 21. In this case, the connecting device integrated in the portable personal computer 21 is preferably suitable for determining the location of the portable personal computer 21 automatically, in particular with the aid of satellites 20.

Instead of the personal computer 21, it is also possible for only a mobile telephone with an integrated connecting device to be present as the terminal. It should be pointed out that, in the case of the personal computer 21 or the telephone in FIG. 2, it may sometimes no longer be possible to locate the connecting device as a separate unit.

With the aid of the portable personal computer 21, or of the mobile telephone, by virtue of the current location determined by the integrated connecting device, the user of the personal computer 21 or of the telephone can be informed of location-dependent information. For instance, the user may be informed automatically of the currently nearest petrol stations, hotels, hospitals or the like.

This can be done if the personal computer 21, or the telephone, passes the currently determined location to the fixed LAN 10, and if only the data relevant to this location is then passed by this LAN 10 to the personal computer 21, or to the telephone. This avoids, for example, transmitting all the petrol stations or hotels from the databases 12 to the personal computer 21, or to the telephone.

The personal computer 21, or the telephone, can then be moved geographically by the user to any desired location. By virtue of the preferably automatic determination of the current location, the user always receives the relevant data without having to do anything.

What is claimed is:

1. Method for operating a preferably mobile telecommunication system, in which at least one terminal is coupled via an connecting device to a public network, wherein in that the location of the connecting device is entered manually or determined automatically.

2. Method according to claim 1, wherein in that the location of the connecting device is determined with the aid of satellites, in particular with the aid of GPS satellites.

3. Method according to claim 1, wherein in that the location of the connecting device is determined with the aid of information which is broadcast by wireless public networks, in particular by GSM and UMTS networks.

4. Method according to claim 1, in which a fixed LAN is connected to the public network wherein in that only data associated with the location of the connecting device is transmitted from the LAN to the terminal.

5. Telecommunication system having a public network to which at least one terminal is coupled via an connecting device, wherein in that the location of the connecting device is stored in the connecting device.

6. Telecommunication system according to claim 5, wherein in that the connecting device is provided with means for automatically determining the location of the connecting device.

7. Telecommunication system according to claim 5, wherein in that the terminal and the connecting device are components of a preferably wireless LAN.

8. Telecommunication system according to claim 5, wherein in that the terminal and the connecting device are designed as an integrated device, for example as a personal computer or as a telephone.

9. Connecting device for a telecommunication system, using which a terminal can be coupled to a public network, wherein in that the location of the connecting device is stored in the connecting device.

10. Personal computer, in which an connecting device for a telecommunication system is integrated, using which the personal computer or the telephone, respectively, can be coupled to a public network, wherein in that the location of the personal computer is stored in the personal computer or in the connecting device.

11. Telephone, in which an connecting device for a telecommunication system is integrated, using which the telephone can be coupled to a public network, wherein the location of the telephone is stored in the telephone or in the connecting device.
